(19) United States
(12) Patent Application Publication
(10) Pub. No.: US 2009/0106036 A1
(43) Pub. Date: Apr. 23, 2009

(54) METHOD AND SYSTEM FOR MAKING AUTOMATED APPOINTMENTS

(76) Inventors: Kazuya Tamura, Rancho Palos Verdes, CA (US); Robert Uyeki, Torrance, CA (US); Harry Harris, Cerritos, CA (US)

Correspondence Address: O''Melveny & Myers LLP;IP&T Calendar Department LA-13-A7, 400 South Hope Street, Los Angeles, CA, 90071-2899, US

(21) Appl. No.: 11/876,758

(22) Filed: Oct. 22, 2007

(51) Int. Cl. G06Q 50/00

(52) U.S. Cl. 705/1

(57) ABSTRACT

Methods and systems for scheduling vehicle service appointments from a remote site via an onboard system are provided. For example, there is provided a method for broadcasting vehicle event information to a plurality of vehicles that can include product update information and vehicle maintenance reminders. The user is able to respond to the vehicle event by requesting a service appointment from a desired dealer using the onboard system to communicate with a remote site using a cellular data line over a wireless communication network. In one embodiment, a proposed service appointment date and time is presented to the user. The proposed appointment date and time is based on the vehicle user's preference setting and a dealer's schedule corresponding to the dealer selected by the user. Proposed service appointment dates and times are released to other users when the user has not confirmed the appointment during a predetermined response time.

### BACKGROUND OF THE INVENTION

1. Field of the Invention

Systems and methods are provided for automatically setting, rescheduling, and canceling appointments. More particularly, the systems and methods provide ways to set and change appointments on a server at a remote site accessed via an onboard system.

2. Description of Related Art

Currently many vehicles are equipped with onboard computer diagnostic systems that have the ability to self-diagnose vehicle system failures, as well as providing maintenance-type reminder messages to the user based on the number of miles the vehicle has been driven or elapsed time from a prior service visit. Service reminders are sent to the user at regular time intervals, for example sending an oil change reminder every three months. The hope with such systems is that a reminder for a service reminder (e.g., a 30,000 mile brake inspection) will be received when the vehicle has around 30,000 miles on the odometer and that the user will take the initiative to timely schedule a service appointment. Some existing vehicle notification systems can receive service reminders that are wirelessly communicated with a user's vehicle from an external computer system. Such systems can receive additional types of messages such as product update notices and other vehicle related messages such as service specials and advertisements for vehicle accessories.

Recently onboard vehicle maintenance notification systems have advanced to the point of allowing the user to request a service appointment that is wirelessly communicated to a remote computer system at the time a service message or other vehicle event message occurs or at a later, more convenient time. These systems lack certain features for optimizing the setting and managing of service appointments, both from the perspective of the vehicle user and from the perspective of the vehicle dealer service department. For example, a system that prioritizes the service requests received from users based on the urgency of the service request and/or takes into consideration the personal schedule or preferences of the vehicle user would be an advance over existing systems that merely present the user with a list of available service appointment dates and times (“slots”) and put the burden of checking these slots against the user's personal schedule on the user. Further, when several service times need to be addressed by a service appointment, the user may likely have difficulty in determining the priority of vehicle issues that need to be addressed. This is especially true when the user is presented with cryptic service messages such as vehicle diagnostic trouble codes (“DTC”). From the perspective of the servicing dealer, a system that maximizes the number of scheduled vehicle service appointments for all the available time slots, while minimizing the tying up of appointment slots for unconfirmed appointments would be desirable. Other desirable features for vehicle notification systems include the ability to manage appointments that were previously set. For example, it would be desirable for a user to be able to modify (e.g., cancel or reschedule) appointments from her vehicle without having to manually telephone the dealership to do so (e.g., calling the desired dealer on a cellular audio line).

Accordingly, a need exists for a method and system for communicating service and maintenance information to and from a server at a remote site and utilize that information to schedule, reschedule and otherwise manage appointments utilizing the vehicle's onboard system. More specifically, the need exists for the onboard system that manages appointments in a manner that takes into account the urgency of the vehicle event, while considering the user's personal schedule. Moreover, there remains a need for the server at the remote site to manage the available appointment slots for a plurality of users in such a manner that maximizes the scheduling of available appointment slots for the service providers, while tying-up or holding an available appointment slot just long enough for a particular user to confirm the potential appointment place, date and time.

### SUMMARY OF THE INVENTION

The present invention addresses the shortcomings of the prior art system and methods. In particular, the present invention is directed to systems and methods for setting and revising service appointments from an onboard system based upon both the dealer's schedule and the user's schedule, in a manner that maximizes the scheduling of available time slots for the dealer, while providing the user with the ability to temporarily reserve an appointment slot. An appointment request for a service issue that rises above a predetermined level receives the first available appointment in the selected dealer's schedule. An onboard system comprising an information platform unit communicates with a plurality of remote servers via both a satellite broadcast system and a cellular telephone network. The information platform unit can be paired with the cellular telephone over a Bluetooth communications link, though other wireless and wired communications methods and protocols are within the scope of the invention.

In accordance with one aspect of the embodiments described herein, there is provided a method for scheduling vehicle service appointments for a vehicle user. The method generally comprises receiving information about a vehicle event, identifying a dealer to service the vehicle event, accessing a dealer schedule of the identified dealer, and determining whether the user has provided scheduling preferences in a user profile. The method further comprises selecting a preference-based appointment time in the dealer schedule according to the scheduling preferences when the user profile includes the scheduling preferences, selecting a first available appointment time in the dealer schedule when the user profile does not include the scheduling preferences, and sending a proposed appointment time to a vehicle user.

In accordance with another aspect of the embodiments described herein, there is provided a method for scheduling vehicle service appointments for a vehicle user. The method generally comprises detecting a vehicle event, sending vehicle information to a remote site, and receiving a proposed appointment time with a dealer from the remote site. Receiving a proposed appointment time comprises receiving a preference-based appointment time in a dealer schedule according to scheduling preferences of the user when the user has provided the scheduling preferences in a user profile. Receiving a proposed appointment time further comprises receiving a first available appointment time in the dealer schedule when the user profile does not include the scheduling preferences.

In accordance with another aspect of the embodiments described herein, there is provided a system for scheduling vehicle service appointments for a vehicle user. The system generally comprises a receiver unit for receiving information about a vehicle event, a processor unit that is operatively coupled to the receiver unit, and a transmitter unit that is operatively coupled to the processor unit for sending a proposed appointment time to a vehicle user. The processor is programmed to identify a dealer to service the vehicle event, access a dealer schedule of the identified dealer, and to determine whether the user has provided scheduling preferences in a user profile. The processor is further programmed to select a first available appointment time in the dealer schedule when the user profile does not include the scheduling preferences, and to select a preference-based appointment time in the dealer schedule according to the scheduling preferences when the user profile includes the scheduling preferences.

In accordance with another aspect of the embodiments described herein, there is provided a system for scheduling vehicle service appointments. The system generally comprises a detector for detecting a vehicle event, a transmitter unit, and a processor unit that is operatively coupled to the detector and transmitter unit. The processor unit is programmed to instruct the transmitter unit to send vehicle information to a remote site when the detector detects the vehicle event. The system further comprises a receiver unit that receives a proposed appointment time with a dealer from the remote site, and a display unit for displaying the proposed appointment time for the user. The receiver unit receives a preference-based appointment time in a dealer schedule according to scheduling preferences of the user when the user has provided the scheduling preferences in a user profile. The receiver unit further receives a first available appointment time in the dealer schedule when the user profile does not include the scheduling preferences.

A more complete understanding of the system and method for making and changing appointments via an onboard vehicle system will be afforded to those skilled in the art, as well as a realization of additional advantages and objects thereof, by a consideration of the following detailed description of a preferred embodiment. Reference will be made to the appended sheets of drawings that first will be described briefly.

### BRIEF DESCRIPTION OF THE DRAWINGS

FIG. 1a is a schematic diagram of an embodiment of a system pursuant to aspects of the invention;

FIG. 1b is a schematic diagram of a broadcast communication network according to an embodiment of the system and method;

FIG. 1c is a schematic diagram of a navigation device in communication with a mobile unit according to an embodiment of the system and method;

FIG. 1d is a block diagram of a navigation system utilizing an onboard hands free telephone device according to an embodiment of the system and method;

FIG. 2 is a block diagram of an embodiment of a system for making automated appointments from an onboard system that communicates with a remote server;

FIG. 3 is a block diagram of the interaction of the onboard system and the server in an embodiment of a method for making automated appointments;

FIG. 4 is a schematic diagram of one embodiment of a system for displaying filtered automated appointment information to a user;

FIG. 5 is a screen image flow diagram for utilizing a navigation system to view different types of automated appointment messages according to an embodiment of the system and method;

FIG. 6a is a screen image flow diagram for finding a service dealer for making an automated appointment via the onboard system according to an embodiment of the system and method;

FIG. 6b is a screen flow image diagram for scheduling an automated appointment after a recall notice or product update message is displayed on the onboard system screen according to an embodiment of the system and method;

FIG. 6c is a screen flow image diagram for canceling an automated appointment after an appointment reminder message is displayed on the display screen of the onboard system according to an embodiment of the system and method;

FIG. 7a is a flow diagram of an embodiment of a method for making automated appointments using a dealer's schedule;

FIG. 7b is a flow diagram of an alternate embodiment of a method for making automated appointments using a dealer's schedule and the customer's preference settings;

FIG. 7c is a flow diagram of an alternate embodiment of a method for making automated appointments based on the ranking of the severity of the issue necessitating an appointment.

### DETAILED DESCRIPTION OF THE PREFERRED EMBODIMENT

Methods and systems are provided for requesting service appointments from a remote site via an onboard system in response to a vehicle event. The preference settings of both the user and of the dealer can be considered in arriving at a proposed appointment date and time, and the computation of the appointment date and time can be processed by the onboard system or at the remote site. As will be discussed below, messages communicated between an onboard system and a server at a remote site are transformed or converted to XML format for compatibility, but one of skill in the art will recognize that other markup languages can be used as well, such as SGML and HTML. It should be appreciated that the system and method is not limited to dealing with setting service appointments for automobiles, but would be equally applicable to other types of vehicles and equipment such as busses, commercial trucks, aircraft, boats, and industrial machinery as well. In the detailed description that follows, like element numerals are used to describe like elements illustrated in one or more of the figures.

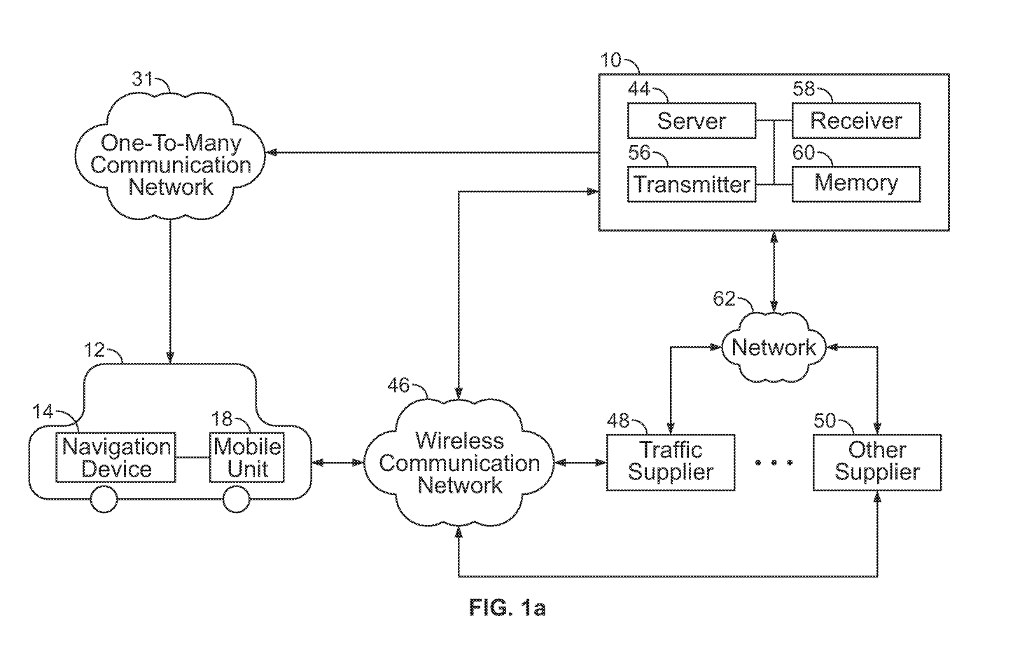

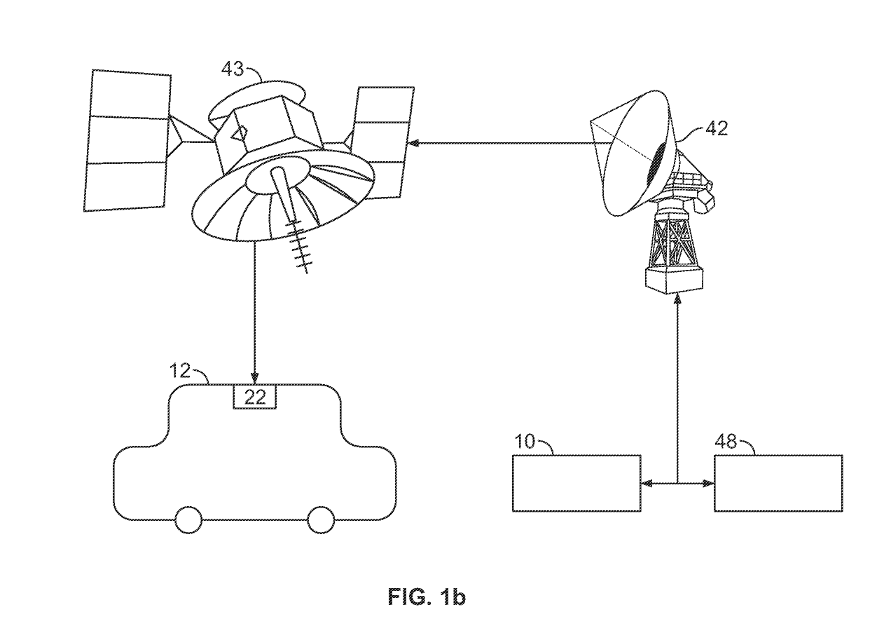

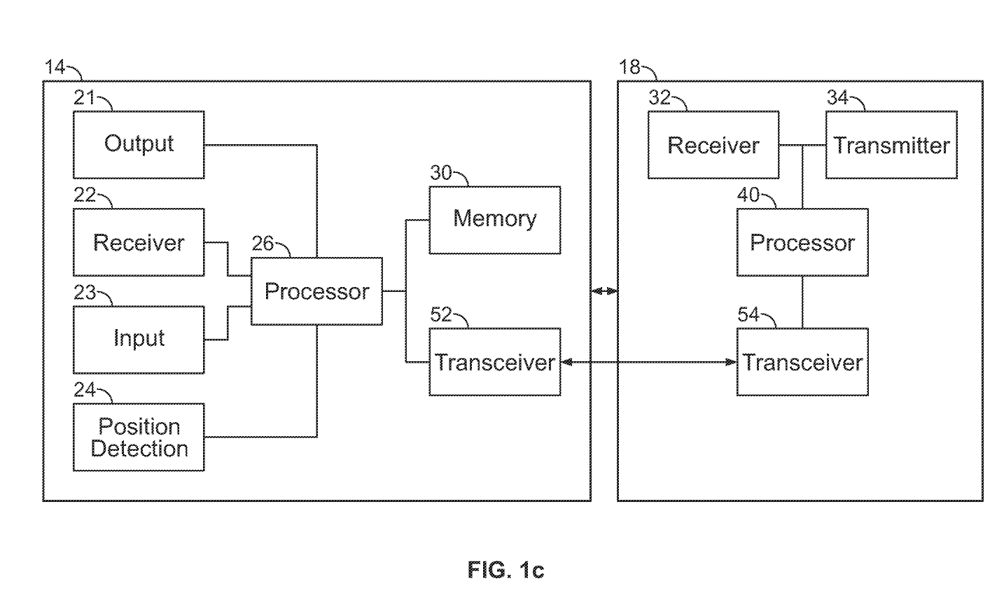

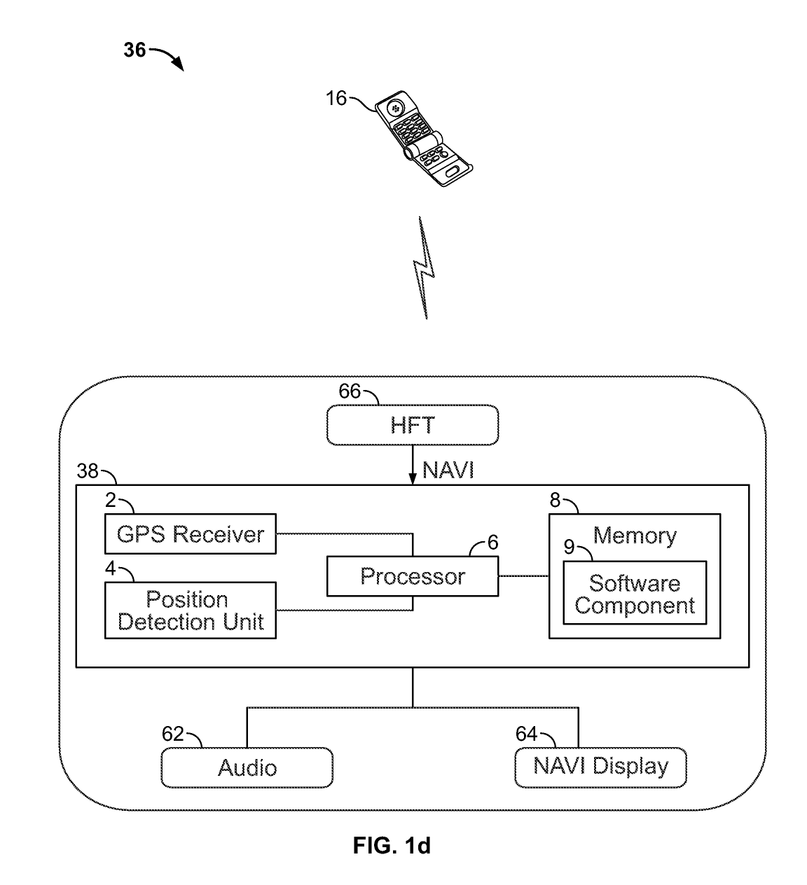

With reference to FIG. 1a, a first embodiment of a system for facilitating the exchange of information between a remote location 10 and a vehicle 12 is illustrated pursuant to aspects of the invention. The vehicle 12 includes a navigation device 14. Referring now also to FIG. 1c, the navigation device 14 may include an output unit 21, a receiver unit 22, an input unit 23, a position detection unit 24, a navigation memory unit 30, a navigation processor unit 26, and an RF transceiver unit 52 that are all in electrical communication with one another. The navigation memory unit 30 includes at least a portion of a user profile and in some embodiments may include the entire user profile. In addition, the navigation memory unit 30 includes a road map database portion and, in some embodiments, includes a disk reading unit (such as a DVD or CD-ROM) for reading road map information not built into the navigation device 14. As is provided in greater detail below, the user profile and/or the road map database stored in the memory 30 may be updated in the vehicle by way of the input unit 23, which can include at least one of a keyboard, a touch sensitive display, and a microphone. The user profile and/or the road map database may also be updated by way of information received through the receiver unit 22 and/or the RF transceiver unit 52.

The receiver unit 22 receives information from the remote location 10 and, in one embodiment, is in communication with the remote location by way of a one-to-many communication system. One-to-many communication systems include systems that can send information from one source to a plurality of receivers, such as a broadcast network 31. Broadcast networks include television, radio, and satellite networks. FIG. 1b is a schematic diagram of one embodiment of the broadcast network 31 that comprises a radio satellite network. The satellite network comprises broadcast towers 42, satellite servers (not shown), and satellites 43. The broadcast towers 42 transmit information to the satellites 43, which relay the information back down to the receiver unit 22 of the navigation device 14.

Referring once again to FIG. 1c, the information received by the receiver 22 may be processed by the navigation processor unit 26. The processed information may then be displayed by way of the output unit 21, which includes at least one of a display and a speaker. In one embodiment, the receiver unit 22, the navigation processor unit 26 and the output unit 21 are provided access to only subsets of the received broadcast information based on user preferences and/or traffic information demands. The user preferences, as well as user identity information, traffic-related information and point of interest information, can be part of the user profile.

The position detection unit 24 may include a GPS receiver that communicates with a plurality of GPS satellites to determine the position of the vehicle 12 (shown in FIG. 1a). For example, the GPS receiver searches for and collects GPS information (or signals) broadcast from three or more GPS satellites that are in view of the GPS receiver. Next, using the time interval between the broadcast time and reception time of each broadcast signal, the GPS receiver calculates the distance between the GPS receiver and each of the three or more GPS satellites (a process known in the art as trilateration). These distance measurements, along with the position and time information received in the broadcast signals, allow the GPS receiver to calculate the geographic position of the vehicle 12.

Returning now to the embodiment shown in FIG. 1a, the mobile unit 18 is used to receive and transmit information from and to the remote location 10. The mobile unit 18 may be a wireless telephone or any other device that communicates with other devices by way of the wireless communication network 46. The details of the mobile unit 18 are shown in the embodiment of FIG. 1c, wherein the mobile unit 18 includes a wireless receiver 32, a wireless transmitter 34, a mobile unit processor 40, and an RF transceiver unit 54 that are in communication with one another. The mobile unit 18 is in two-way communication with the remote location 10 (shown in FIG. 1a) by way of the receiver 32, the transmitter 34, and the wireless communication network 46 (shown in FIG. 1a), which comprises numerous base stations. In one embodiment, information is transmitted from or to the vehicle or remote location over a high bandwidth GPRS/1XRTT channel of the wireless communication network 46. If the high bandwidth channel is unavailable, a low bandwidth DTMF channel can be used. The receiver 32 receives information from the remote location 10, and the transmitter 34 transmits information to the remote location 10. In other embodiments, the transmitter 34 also transmits information to suppliers of traffic 48 and/or other information 50.

In one embodiment, the information received from and transmitted to the remote location 10 by way of the mobile unit 18 is accessed by the user through the navigation device 14, which is in communication with the mobile unit 18. The mobile unit 18 may be embedded in the vehicle 12 and be in communication with the navigation device 14 by, for example, a cable (not shown).

In another embodiment, the navigation device 14 and mobile unit 18 are in communication with one another by way of RF transceiver units 54 and 52. Both the navigation device 14 and the mobile unit 18 include RF transceiver units 52, 54, which, in one embodiment, comply with the Bluetooth wireless data communication standard and protocol established by Bluetooth SIG, Inc. or the like. The RF transceiver units 52, 54 allow the navigation device 14 and the mobile unit 18 to communicate with one another. In other embodiments (not shown), the receiver 32 and transmitter 34 of the mobile unit 18 and the receiver unit 22 of the navigation device 14 allow the navigation device 14 and mobile unit 30 to communicate with one another in a unilateral manner. In yet other embodiments, there may be an RF transceiver that is separate from the navigation device 14 and the mobile unit 18 and that allows the navigation device 14 and mobile unit 18 to communicate with one another.

FIG. 1d provides a block diagram of an exemplary system 36 for receiving a message containing navigational data. The system 36 comprises a mobile device or wireless device 16, a Hands Free Telephone 66, a navigation device (“NAVI”) 38, an audio module 62, and a NAVI display 64. The mobile device 16 may be a cellular telephone, personal digital assistant (“PDA”), or any mobile device known in the art that can receive messages such as an SMS message. In a preferred embodiment of the system and method, the system 36 is located in a vehicle, but it should be understood by one of skill in the art that system 36 is not so limited. The mobile device 16 is in communication with the HFT 66. The connection between the mobile device 16 and the HFT 66 may be via a serial cable, a Bluetooth link, an infrared link, or any other type of data communication connection known in the art. In the embodiment shown in FIG. 1d, the mobile device 16 and the HFT 66 are equipped with a Radio Frequency (“RF”) transceiver (not shown) that complies with the Bluetooth wireless data communication standard and protocol established by Bluetooth SIG, Inc. or the like, to allow communication and transferring of messages between the two devices. In a preferred embodiment, the mobile device 16 and the HFT 66 are also equipped with a Dial-Up Networking (DUN) profile that provides a standard to access the Internet and other dial-up services using a Bluetooth connection, as well as supporting SMS commands. One of skill in the art will recognize that the mobile device 16 can also establish a wireless Internet connection by other communication methods such as broadband access over a Code Division Multiple Access (“CDMA”) cellular network.

The HFT 66 is in electrical communication with the NAVI 38, which in turn is in electrical communication with both the audio module 62 and the NAVI display 64. The HFT 66 transfers messages and commands between the mobile device 16 and the NAVI 38. The NAVI 38 acts as the main onboard computer for the navigational system and connects all the components of the system together, as well as performs all routing calculations and the generation of telephone calls via the HFT 66. The NAVI 38 comprises a GPS receiver 2, a position detection unit 4, a processor 6, a memory unit 8, and an intelligent text recognition system software component 9 that distinguishes navigational data such as address and telephone numbers in a message. The GPS receiver 2 receives satellite broadcast signals from three or more GPS satellites orbiting the earth. The position detection unit 4 is operatively coupled to the GPS receiver 2 and can compute the current longitude and latitude coordinates of the vehicle using trilateration (discussed in more detail above with respect to FIG. 1c). The processor 6 can be operatively coupled to the memory unit 8, the GPS receiver 2, and the NAVI display 64. The memory unit 9 can comprise executable code that allows the processor to perform various functions such as running the intelligent text recognition software or instructing the NAVI display 64 to display particular images (e.g., maps and routing information). The NAVI display 64 acts as a visual interface to the user and can be a touchscreen that allows for both the display of data as well as acting as the user interface for entry of information into the NAVI 38. The NAVI 38 can include an optional text-to-speech (“TTS”) engine or software component or unit that interfaces with the audio module 62 to allow messages to be read to the user in an audible format. The NAVI 38 may additionally include a human machine interface (“HMI”) for displaying messages and available commands via the NAVI display 64 and receiving entries from the user by incorporating a touchscreen into the NAVI display or by use of buttons, a keypad, a microphone interconnected to a voice recognition (“VR”) system, or the like.

In a preferred embodiment of the system and method, the mobile device 16 is queried every 15 seconds via the HFT 66 to determine if a new SMS message has been received, but it should be appreciated that other time intervals can be utilized as well. If an SMS message is present, the SMS message is transmitted to the NAVI 38 for storage and can be displayed on the NAVI display 64. It should be appreciated that each component of the system can be integrated together as one hardware system onboard the vehicle or can be utilized as separate components. In another embodiment, the NAVI 38 can be equipped with an RF transceiver (not shown) that complies with the Bluetooth wireless data communication standard and protocol, wherein the NAVI 38 can communicate directly with the mobile device 16 to allow communication and transferring of messages between the two devices without the use of the HFT 66.

The mobile device 16 can act as a Mobile Station (“MS”) and may send or receive SMS messages to and from a Mobile Switching Center (“MSC”) located in wireless proximity to the mobile device 16. The MS comprises all user equipment and software needed for communication with a wireless telephone network. The MSC acts as a telephone exchange that provides circuit-switched calling, mobility management, and services such as voice, data, fax, as well as SMS to mobile phones roaming within the area that the MSC serves. Additionally, in another embodiment, the mobile device 16 can be replaced with an SMS transceiver (not shown) that is located within the NAVI 38, so that the NAVI 38 can directly receive and send SMS messages. Further details regarding embodiments of information exchange between a remote server and a NAVI using a Bluetooth link to a wireless device can be found in U.S. patent application Ser. No. 11/758,535, filed Jun. 5, 2007, entitled “Method And System For Receiving And Sending Navigational Data Via A Wireless Messaging Service On A Navigation System,” the disclosure of which is incorporated in its entirety by reference.

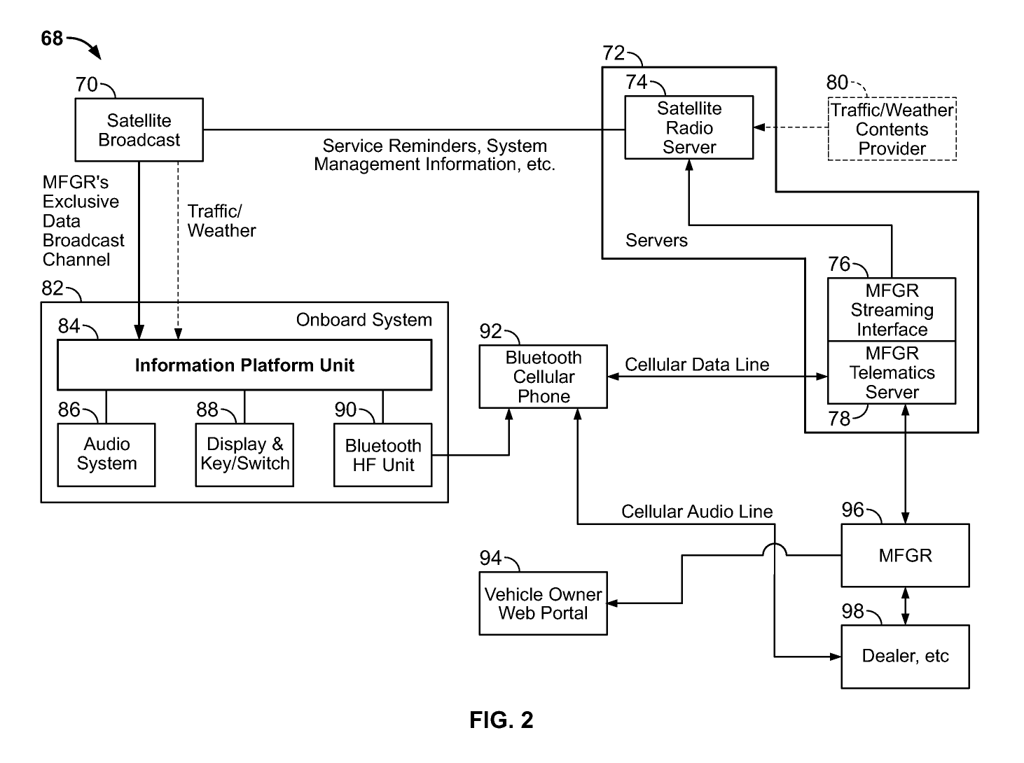

FIG. 2 is a block diagram of an embodiment of a system for making automated appointments from an onboard system 82 that communicates with remote server 72. The system 68 illustrates a more specific embodiment of the system illustrated in FIGS. 1a and 1b. The system 68 comprises an onboard system 82, a satellite broadcast system 70, remote server 72, Bluetooth cellular phone 92, manufacturer 96, servicing dealer or dealer 98, vehicle owner web portal 94, and a contents provider 80. The onboard system 82 combines the reception of information contents from the satellite broadcast system 70 with two-way cellular telephone communication via the Bluetooth cellular phone 92. Both of these communications systems allow the server 72 to communicate with the onboard system 82.

The onboard system 82 comprises an information platform (“IP”) unit or telematics unit 84, an audio system 86, a display & key/switch or keypad or keyboard 88, and a Bluetooth hands free (“HF”) unit 90. The IP unit 84 includes a navigational device (not shown) similar to the NAVI 38 shown in FIG. 1d, that can be integrated into the IP unit 84. The audio device 86 can comprise the audio system that provides audio reproduction for a vehicle's music and entertainment system. The display & key/switch 88 can comprise a touch sensitive NAVI display screen (not shown) or can comprise other types of HMI devices such as a numeric or alphanumeric keypad or keyboard (not shown). The HF unit 90 transmits and receives information from the cellular telephone 92. The operation of the HF unit 90 and the cellular phone 92 function essentially the same as the HFT 66 and the mobile device 16 (see FIG. 1d and related discussion) and in a preferred embodiment, the HF unit 90 electrically communicates with the cellular phone 92 via a Bluetooth communication link.

The onboard system 82 receives information from the satellite broadcast system 70. More specifically, the IP unit 84 comprises a satellite radio receiver (not shown) that can receive multiple channels of information that can comprise a vehicle manufacturer's exclusive data broadcast channel as well as other types of information, such as traffic and weather information that is filtered by geographic region. One of skill in the art will recognize that other criteria for filtering information can be used so that only information received that is of interest to the user will be brought to the user's attention. The data broadcast channel is also filtered, so that only information that pertains to the user's particular vehicle, or to vehicles of the same model and year as the user's, are brought to the user's attention (e.g., by displaying the information on the display and key/switch 88 and/or audibly reproducing the information via the audio system 86). Information broadcast on the data broadcast channel can include service reminders, product update notices, system management information, and the like.

The data information received by the IP unit 84 from the satellite broadcast system 70 and the cellular phone 92 is managed and stored by the remote server 72. In contrast, audio or voice mode telephone calls (such as calls to the dealer for scheduling service appointments and/or obtaining road-side service) transmitted and received by the cellular phone 92 do not use the remote server 72. Such non-data telephone calls are made directly from the cellular phone 92 to the dealer 98. The remote server 72 comprise a satellite radio server 74, a telematics server 78 and a streaming interface 76 that converts, formats, and manages the information from the telematics server 78 so the information can be transmitted by the satellite radio server 74 to the satellite broadcast system 70. Traffic and weather data are supplied to the satellite radio server 74 by a traffic/weather contents provider 80 that is in communication with the satellite radio server 74.

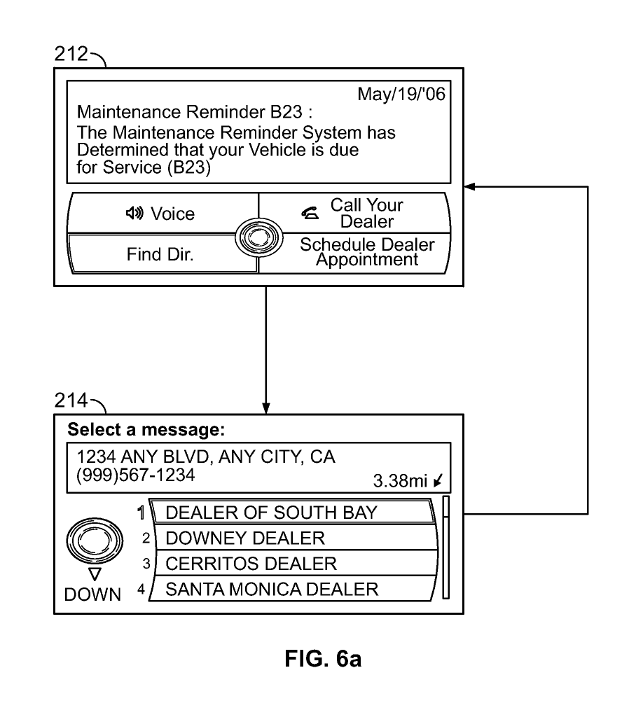

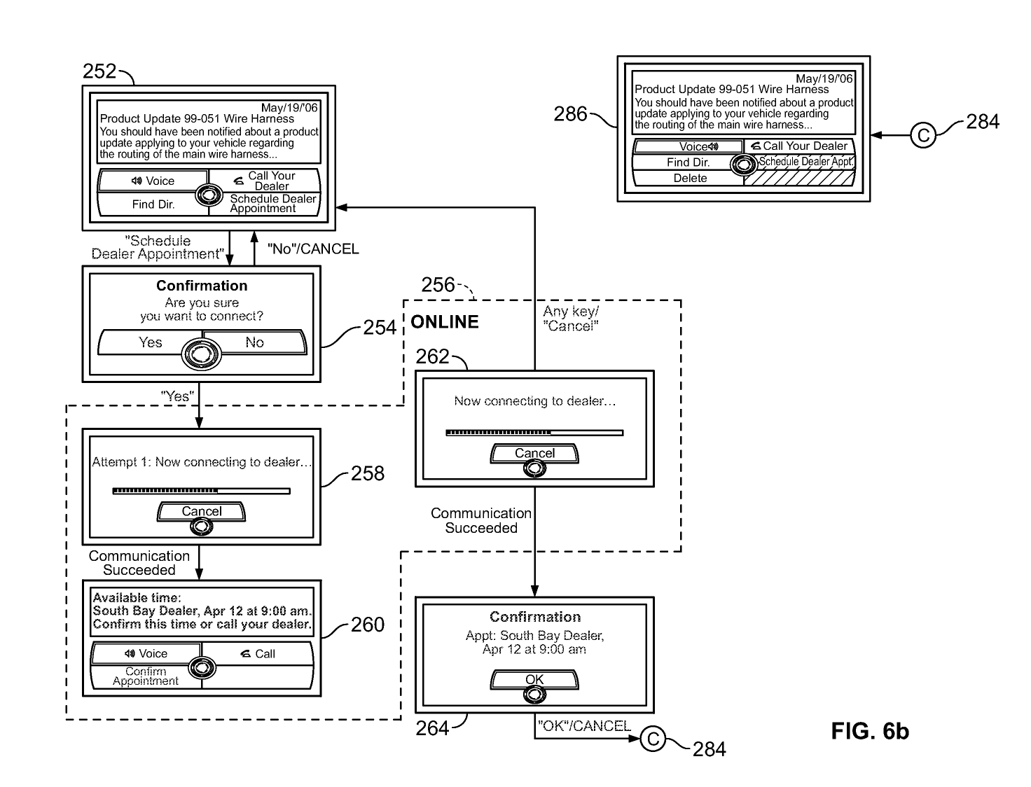

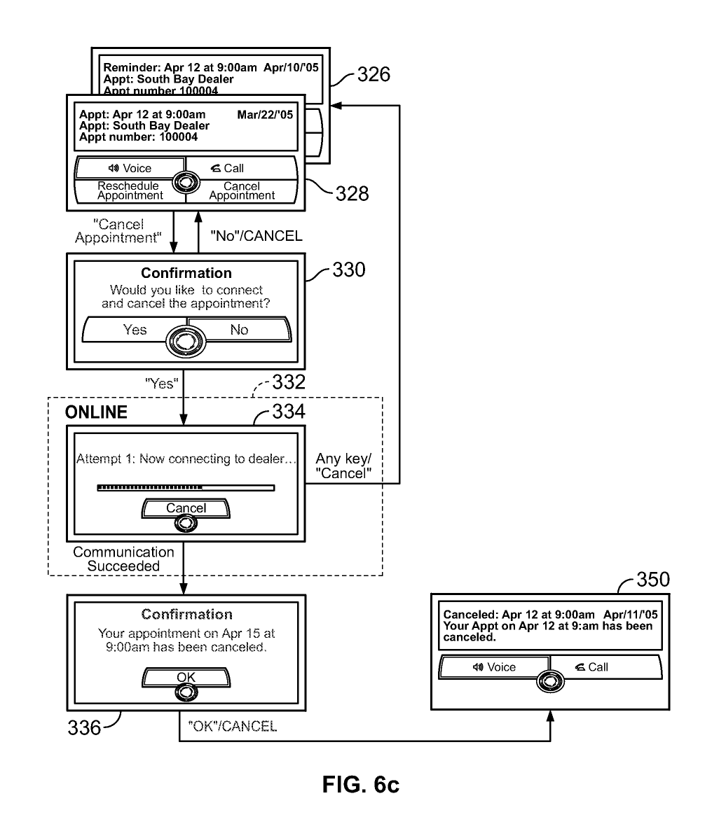

The telematics server 78 manages information from the manufacturer 96 and dealer 98, which can represent a plurality of dealers within a geographic area such as a city or state. The server 78 can also manage information from a parts database that can be stored remotely on a separate server. The telematics server 78 can also obtain a dealer's calendar or service appointment schedule from the dealer 98. The dealer 98 can represent the preferred dealer selected by the user (see FIG. 6A and discussion thereto). With the dealer's calendar corresponding to the calendar corresponding to the same preferred dealer.

Data Information can be transmitted from the IP unit 84 to the manufacturer 98 and dealer 98 via a back channel that utilizes the cellular telephone 92 and a cellular data line connection to the telematics server 78. The information transmitted over the data line can include vehicle diagnosis information, appointment requests, confirmations, and the like. Individualized server messages pertaining to a user's attempts to schedule a dealer appointment and server connection errors can also be transmitted to the IP unit 84 via a cellular data line call to the cellular phone 92. The user can also schedule service appointments, set system user preferences, purchase accessories, etc. 68 via an Internet connection external to the onboard system 82, and using a web browser to access an owner web portal 94. The portal 94 communicates this information with the manufacturer 96 and the dealer 98. To optimize the scheduling of service appointments, the IP unit can also include the user's calendar or schedule (not shown) that can be input directly by the user via the display and key/switch 88 or indirectly by the IP unit 84 communicating with the user's cellular telephone or PDA (not shown).

The server 78 receives and processes information relating to product updates for vehicle products or parts, vehicle maintenance and repairs, the availability of parts at the dealer (from the parts database), the dealer's service appointment schedule, the customer's calendar, and the like. Utilizing these sources of data, the server 78 determines a proposed date and time to schedule the appointment at a particular dealer. In other embodiments, the dealer's calendar can represent the calendars for a plurality of dealers, such as all the dealers in a particular city, county, region, state, and the like. The weighting of the above criteria for determining the date and time of the service appointment can vary according to the preferences of the user, and will be discussed in more detail below, with respect to several embodiments of the system illustrated in FIG. 2.

In a first embodiment, the system further 68 further comprises a receiver unit (such as the receiver 58 (shown in FIG. 1a)) for receiving information about a vehicle event (e.g., the occurrence of a DTC), a transmitter unit (such as the transmitter 56 (shown in FIG. 1a) for sending a proposed appointment time to the vehicle user, and a processor unit (not shown) that is operatively coupled to the receiver 58 and the transmitter 56. The receiver 58, the transmitter 56, and the processor are operatively coupled to a server (such as the server 78 or the server 44). The server 78 is located at a remote site in relation to the user's vehicle 12 (shown in FIGS. 1a and 1b) and can be located at the manufacturer's facilities. The server 78 communicates with the onboard system 82 via a receiver (such as the receiver 58 (shown in FIG. 1a)) and a transmitter (such as the transmitter 56 (shown in FIG. 1a)). The processor unit is programmed to identify a dealer to service the vehicle event, access the dealer's calendar or schedule, and determine whether the user has provided the customer's calendar or schedule in a user profile by communicating with the server 78. The customer's calendar can include the appointments, meeting times, and the like when the user or customer is not available to schedule a vehicle service appointment. The user profile is a set of data that can comprise the user's scheduling preferences (e.g., the days of the week and the times of day that the user prefers when setting a vehicle service appointment).

The processor unit can be further programmed to select a preference-based appointment time in the dealer's calendar to propose the appointment time to the user according to the customer's calendar or scheduling preferences, when the user profile includes the customer's calendar, and to select a first available appointment date and time in the dealer's calendar to propose to the user, when the user profile does not include the customer's calendar. In a variation of this embodiment, the processor unit can be programmed to select the appointment date and time by either of these methods and can be based on a predetermined criterion. The proposed appointment date and time are then sent to the vehicle user (such as by transmitting the information to the onboard system 82 via the transmitter 56) and can be displayed to the user via the display 88.

In an another embodiment, the processor unit is further programmed to determine a priority rank of the vehicle event and to select the first available appointment time in the dealers' calendar, when the priority rank of the vehicle event meets a predefined priority level, regardless of whether the user profile includes the customer's calendar. The processor unit can be programmed to reserve the proposed appointment date and time when the user selects the proposed appointment date and time using the onboard system 82, the Bluetooth cellular telephone 92, the wireless device 16, or from a computer (not shown) via an Internet connection to the server 78 through the owner web portal 94. The processor unit can also be programmed to release the proposed appointment date and time when the user does not select the proposed appointment time during a predetermined response period.

In a variation of the embodiment, receiving information about the vehicle event comprises vehicle identification information. In yet another embodiment, receiving information about the vehicle event comprises receiving a vehicle diagnostic trouble code, and/or a product update message. In still another embodiment, the processor can identify the dealer in proposing an appointment date and time by retrieving data from the user profile.

In a second embodiment, the system further 68 further comprises a detector (not shown) for detecting a vehicle event, a transmitter unit (such as the transmitter 34 (shown in FIG. 1c)) for transmitting vehicle information to a remote site; a receiver unit (such as the receiver 32 (shown in FIG. 1c)) that receives a proposed appointment time with a dealer from a server located at a remote site (such as the server 78 or the server 44), a processor unit (such as the processors 26 and 40 (shown in FIG. 1c)) that is operatively coupled to the detector, the receivers 22 and 32, the transmitter 34 and a display unit (such as the display 88 or the NAVI display 64 (shown in FIG. 1d)) for displaying the proposed appointment time for the user. The processor can be programmed to instruct the transmitter 34 to send vehicle information to the server 78 when the vehicle event is detected by the detector. The server 78 is located at a remote site in relation to the user's vehicle 12. The receivers 22 and/or 32 can receive a proposed appointment date and time with the dealer 98 from the server 78. The proposed appointment time is from a preference-based appointment date and time that is determined from a dealer's calendar or schedule and the customer's calendar or scheduling preferences, when the user has provided her customer calendar in her user profile. The receivers 22 and/or 32 can also receive a first available appointment date and time in the dealer's calendar when the user's profile does not include her customer calendar. The proposed appointment date and time are then sent to the vehicle user and can be displayed to the user via the display 88.

In an alternate embodiment, the receiver 32 receives the first available appointment date and time in the dealer's calendar when a priority rank of the vehicle event meets a predefined priority level, regardless of whether the user profile includes the customer's calendar. The transmitter 34 can send a command to the server 78 to reserve the proposed appointment date and time when the user selects the proposed appointment date and time displayed on the display 88. The user selects the proposed appointment date and time using the onboard system 82, the Bluetooth cellular telephone 92, the wireless device 16, or from a computer (not shown) via an Internet connection to the server 78 through the owner web portal 94. The transmitter 34 can also send a command to the server 78 to release the proposed appointment date and time when the user does not select the appointment date and time displayed on the display 88 during a predetermined response period.

In a variation of the embodiment, detecting a vehicle event comprises detecting a mileage-based event (e.g., a tune-up is needed at 30,000 miles on the vehicle). The detector can also detect a condition-based event (e.g., if the vehicle has been driven greater than 30,000 miles and excessive heat in the brake rotors is detected, a condition-based event will be triggered). In another embodiment, detecting a vehicle event comprises a vehicle diagnostic trouble code. In yet another embodiment, detecting a vehicle event comprises receiving a product update message.

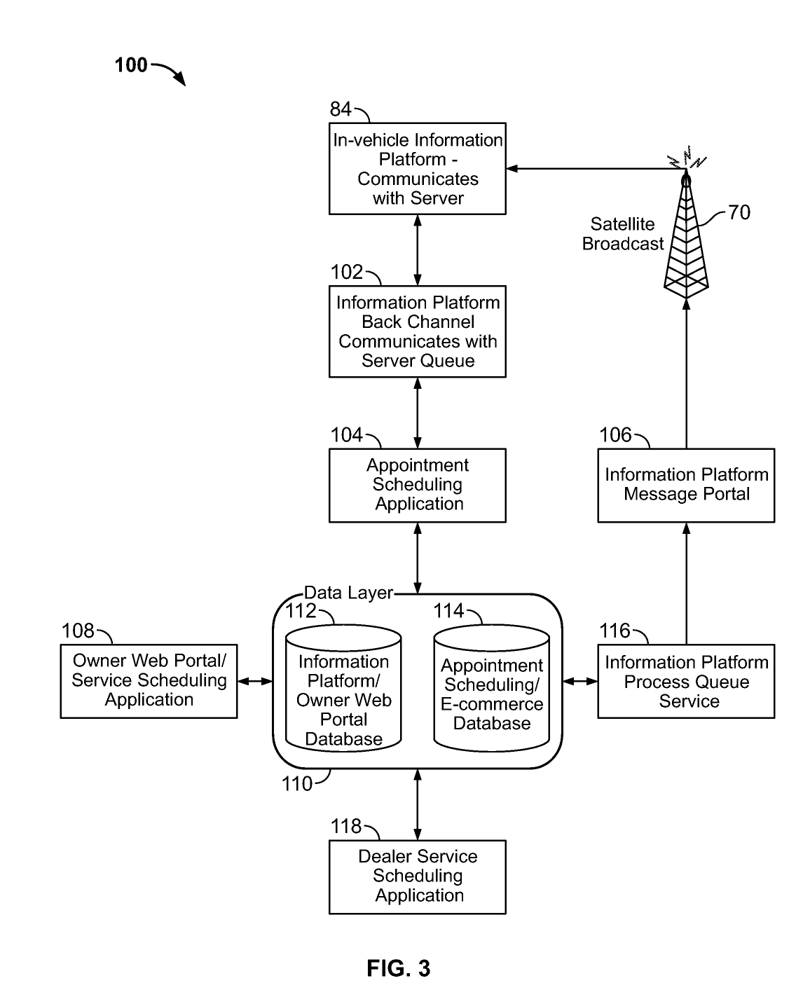

FIG. 3 is a block diagram illustrating the interaction of the onboard system 82 (shown in FIG. 2) and the remote server 72 (shown in FIG. 2) in an embodiment of a method for making automated appointments. An in-vehicle information platform (“IP”) or IP unit 84 and an information platform back channel 102 are part of the onboard system 82. With the exception of the satellite broadcast system 70, the IP unit 84, and the IP back channel 102, the remaining items illustrated in FIG. 3 are part of the remote server 72. The system 100 comprises the in-vehicle information platform unit 84, the information platform back channel 102, an appointment scheduling application 104, an information platform message portal 106, a portal/service scheduling application 108, a data layer 110, an information platform process que service 116, and a dealer service scheduling application 118. Data layer 110 contains the stored data for the portal/service scheduling application 108, the appointment scheduling application 104, and the dealer service scheduling application 118. The data layer 110 comprises the information platform/web portal database or IP database 112 and the appointment scheduling/e-commerce database or e-commerce database 114. In a preferred embodiment, these two databases are physically distributed between two clustered database servers, but “viewed” as a single logical entity in the data layer 110 by the appointment scheduling application 104.

The appointment scheduling application 104 sets and manages vehicle user appointments utilizing the data in the data layer 110 and the data input into the IP unit 84 by the vehicle user, as described with respect to FIG. 2, above. The information platform back channel 102 communicates information from the IP unit 84 to the remote server 72 via an alternate transmission method, separate from the satellite broadcast system 70, which is a one-way method of transmitting information from the remote server 72 to the IP unit 84. The IP back channel 102 comprises the wireless communications network 46 (shown in FIG. 1) and in a preferred embodiment, the IP unit 84 uses the Bluetooth HF unit 90 (shown in FIG. 2) and the Bluetooth cellular phone 92 (shown in FIG. 2) to access the wireless network 46. The remote server 72 transmit one-way service reminders, recall notices, and the like, by communicating the information to the information platform process queue service 116, which manages the transmittal of messages for the satellite broadcast system 70. For example, the queue service 116 serializes concurrent demands for data to be broadcast by the satellite system 70. The data to be broadcast is first passed to the information platform message portal 106, which is the gateway for sending messages from the applications running on the remote server 72 (e.g., the appointment scheduling application 104 and the dealer service scheduling application) to the satellite broadcast system 70. The information platform message portal 106 enables data to flow from these applications to the satellite broadcast system 70 by first converting the different data protocols utilized to allow the data to be routed to the satellite broadcast system 70.

The dealer service scheduling application 118 allows dealers to control certain aspects of the service schedule that is utilized by the appointment scheduling application 104 in scheduling appointments with vehicle users. For example, the dealer service scheduling application 118 allows dealers to provide their service schedule offering, including the volume of appointments they will accept for a particular date and time slot, as well as particular types of service appointments they can perform in the evenings and/or weekends. The database that stores the data for the dealer service scheduling application 118 is the appointment scheduling/e-commerce database 114. The dealer service scheduling application 118 can be accessed remotely by participating dealers via a proprietary software application running on a computer located at the dealer or in other embodiments, the software application can be accessed via a secure website portal on the Internet.

Conversely, the portal/service scheduling application 108 allows registered vehicle owners to access the appointment scheduling application 104 from any computer that has Internet access and a compatible web browser. This application allows registered vehicle owners to set their user preferences that can include their personal calendar (e.g., days and times of the week they are available to make a service appointment if needed), preferred dealership, payment option defaults, and the like. The vehicle user can also directly schedule a service appointment over the Internet as opposed to telephoning a dealer on an audio mode cell phone or setting an appointment from within her vehicle utilizing the IP unit 84. The database that stores the data for the portal/service scheduling application 108 is the information platform/web portal database 112.

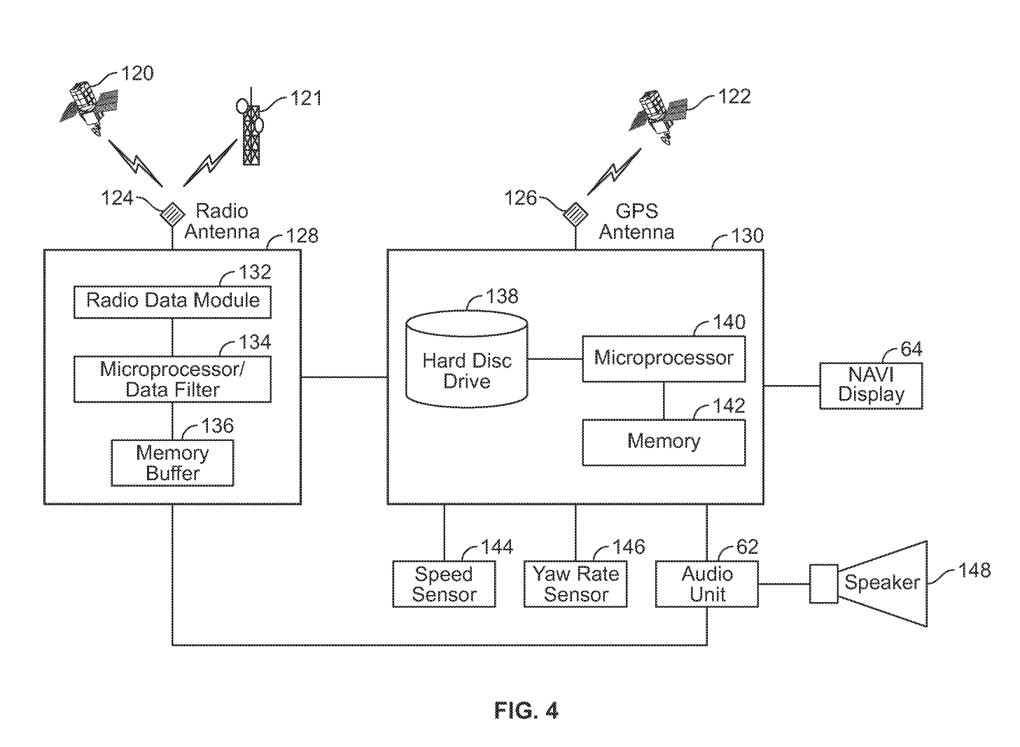

FIG. 4 is a schematic diagram of one embodiment of a system for displaying filtered automated appointment information to a user. When a vehicle navigation system receives point of interest data broadcasts, a data filter is commonly utilized to reduce unnecessary data from the data received. For example, the filter can be used to discard all available appointment date and time information for dealerships beyond a set distance from the vehicle's current location or product update notices that don't apply to the user's vehicle. An existing method of reducing user wait time while the vehicle navigational system is initializing and processing the received data, utilizes a data packet filter that removes redundant data being repeatedly broadcast. This is accomplished by the data packet filter checking the cyclic redundancy code (“CRC”) of the data packets. Such a method of reducing duplicate data is an improvement over methods that do not check the CRC for duplicates (those methods merely use the CRC codes to verify data integrity and reduce transmission errors), and the embodiment shown in FIG. 4 significantly reduces the wait time for a user that wishes to use the navigation system to make and change automated appointments as compared to solely using CRC codes to eliminate duplicate data, as explained in further detail in U.S. patent application Ser. No. 11/756,611, filed May 31, 2007, entitled “System And Method For Selectively Filtering And Providing Event Program Information,” the disclosure of which is incorporated in its entirety herein by this reference.

The navigational system illustrated in the embodiment of FIG. 4 operates similarly to the embodiments of FIGS. 1c and 1d, described above, but has additional components and features described below. The embodiment of FIG. 4 comprises satellite-based or digital FM-based radio broadcast antennas 120 and 121, a satellite-based GPS antenna 122, a radio antenna 124, a GPS antenna 126, a data receiver unit 128, a navigational device or NAVI 130, NAVI display 64, a speed sensor 144, a yaw rate sensor 146, an audio unit or voice output device 62, and a speaker 148. The data receiver unit 128 comprises a radio data module 132, a microprocessor/data filter 134, and a memory buffer unit 136. The navigational device 130 comprises a hard disk drive 138, a microprocessor 140, and a memory unit 142.

Looking closely now at the NAVI 130, the microprocessor 140 processes user commands entered on the NAVI display 64 or other input device (not shown), as well as the location data received via the GPS antenna 126 and filtered database information from the microprocessor/data filter 134. The memory unit 142 can include at least a portion of a user profile and in some embodiments may include the entire user profile that stores user preferences such as the user's preference settings, calendar, preferred dealership names, vehicle identification number (“VIN”), year, model, and distances from the vehicle's current location that the user is interested in using as a filtering criteria. The memory unit 142 includes a road map database portion, a dealership information or Facility ID database and, in some embodiments, includes a DVD unit for reading road map information not built into the navigation device. A plurality of other database information and database updates, such as points of interest information, product updates/recall notices, dealer schedules, and proposed appointment dates and times are received from the data receiver unit 128 and are stored in the memory unit 142.

The speed sensor 144 and the yaw rate sensor 146 are in electrical communication with the NAVI 130 and are used to determine estimates of times to arrive at points of interest, such as a dealership for a service appointment, from the vehicle's current location. The speed sensor 144 and the yaw rate sensor 146 can also be used to determine the most efficient travel routes to the desired servicing dealership. In one embodiment, the estimated times to travel to a plurality of dealerships are displayed to assist the user in deciding which dealership she would like to choose to service her vehicle or to receive further information about that dealership from the NAVI 130.

The audio unit 62 is in electrical communication with the data receiver unit 128, the NAVI 130, and the speaker 148. The audio unit 62 comprises an audio processor (not shown), amplifier (not shown), and speech synthesizer (not shown). The audio unit 62 can provide verbal warnings and announcements to the user (e.g., service reminders), as well as driving directions by the coupling of the audio unit 62 to the speaker 148. Variations of this embodiment include the use of confirming tones or beeps that can be produced when a user selects a command or menu on the NAVI display 64. Another variation utilizes a human voice synthesis of the text portion displayed on the NAVI display 64 such as the available service appointment dates and times, service reminders and product updates/recall notices. The speaker 148 can be the same device utilized by the user to listen to radio, CD-ROM, DVD and other audio sources that can be accessed in the vehicle by the user.

The NAVI display 64 is in electrical communication with the NAVI 130 and displays a variety of types of information to the user, such as digital maps and routes that guide the user to a dealership location, as well as other points of interest information utilizing a variety of submenus. The display can show text, images and video clips to the user, such as an illustration of the service required to correct a current problem with her vehicle. The NAVI display 64 can be a touch display that shows icons that are activated when a user touches them with her finger.

Looking closely now at the data receiver unit 128, the microprocessor/data filter or filter 134 processes a plurality of types of data received by the radio data module 132 and updates data stored in the hard disk drive 138 and memory unit 142. A key function of the filter 134 is that it filters the large volume of data received by the data module 132 so that only information relevant to a user is sent to the NAVI 130 for processing and ultimately, for display by the NAVI display 64.

In many vehicle navigation system applications, the data receiver unit 128 initializes quicker than the NAVI 130 and the receiver unit 128 must wait for the slower NAVI 130 to initialize and then to communicate instructions and data before the filter 134 can complete the data filtering function. The use of the memory buffer unit 136 allows the receiver unit 128 to receive, process and filter data received in substantially real time from the antennas 120 and 121, as well as automated appointment data previously received from the NAVI 130 shortly after the vehicle's ignition is switched on. More specifically, before the vehicle's ignition was turned off last cycle, the memory buffer 136 was sent the vehicle's current location coordinates as well as portions of the automated appointment and points of interest database data by the microprocessor 140. Shortly after the ignition switch is turned on, periodic data broadcasts are received from the antennas 120 and 121, and the filter 134 can start processing and filtering both the data received and the information stored in the memory buffer 136. The resulting filtered data can then be temporarily stored in the memory buffer 136 until the NAVI 130 initialization is completed and the NAVI 130 can receive outgoing data from the data receiver unit 128.

A data packet containing appointment information can be broadcast to vehicles by the satellite broadcast system 70 (shown in FIGS. 2 and 3) as part of the one-to-many communications network 31 (shown in FIG. 1a). The appointment information in the data packet is intended for one particular vehicle. Other portions of the broadcast data (not shown) can contain a filter code section that defines certain characteristics of the vehicle to which the message applies (not shown), such as the relevant vehicle identification number (“VIN”). All vehicles in a particular geographic region would receive the same satellite broadcast signal from the satellite broadcast system 70, but the NAVI 14 (shown in FIG. 1a) for the receiving vehicles filter out the non-relevant messages. The NAVI 14 of only the one vehicle to which the message is directed towards, does not filter out the received message.

The receiver 22 (shown in FIG. 1b) in the vehicle 12 receives the entire broadcast data message and a filter processing section uses the filter code section to identify message portions that are intended for the vehicle 12. Message portions that are not applicable to filter criteria set by the user or vehicle manufacturer for the vehicle 12 are discarded by a filter processing section located within the mobile unit 18. The intended messages are then stored in the memory 30 (shown in FIG. 1c) or on a hard-drive and indexed by an applicable criteria. The broadcast data can contain a header that provides information about the broadcast data portion of the received message, including instructions and preferences about the manner and timing of presentation of the broadcast data portion to the vehicle operator.

The filter processing section in the vehicle 12 can use the criteria defined in the filter code section together with the broadcast data header to determine whether to present the data message to the vehicle operator or to discard the data message. The data message can include a header, a payload section, and a cyclic redundancy code (“CRC”).

A payload section of the broadcast data packet (not shown), which is between the header and the CRC code, includes the filter section and the broadcast data. The CRC code may be generated using any suitable algorithm such as, but not limited to, the following polynomial function:

G(X)=X16+X15+X2+1

It should be appreciated that when the same message data is broadcast to a plurality of vehicles belonging to a common group, and when there are large numbers of target vehicles in the target group, the overall data amount is small (i.e., the broadcast efficiency is high). The payload section may include one set of broadcast data or multiple sets of broadcast data. That is, depending on the length of the message body, the broadcast message may comprise a single packet or multiple packets. For a single packet message, a header and CRC code is created and added to the source data to produce the broadcast data packet (not shown). Alternatively, for a multiple packet message, the message body is partitioned into sections and each section has a header and the CRC code added thereto. It will also be understood that the CRC code is merely exemplary, and that any other suitable method of checking for errors in the data message can be implemented with the present invention. Further details regarding multiple packet broadcast data messages are provided in U.S. patent application Ser. No. 11/266,879, filed Nov. 4, 2005, and entitled “Data Broadcast Method for Traffic Information;” the disclosure of which is incorporated in its entirety herein by reference.

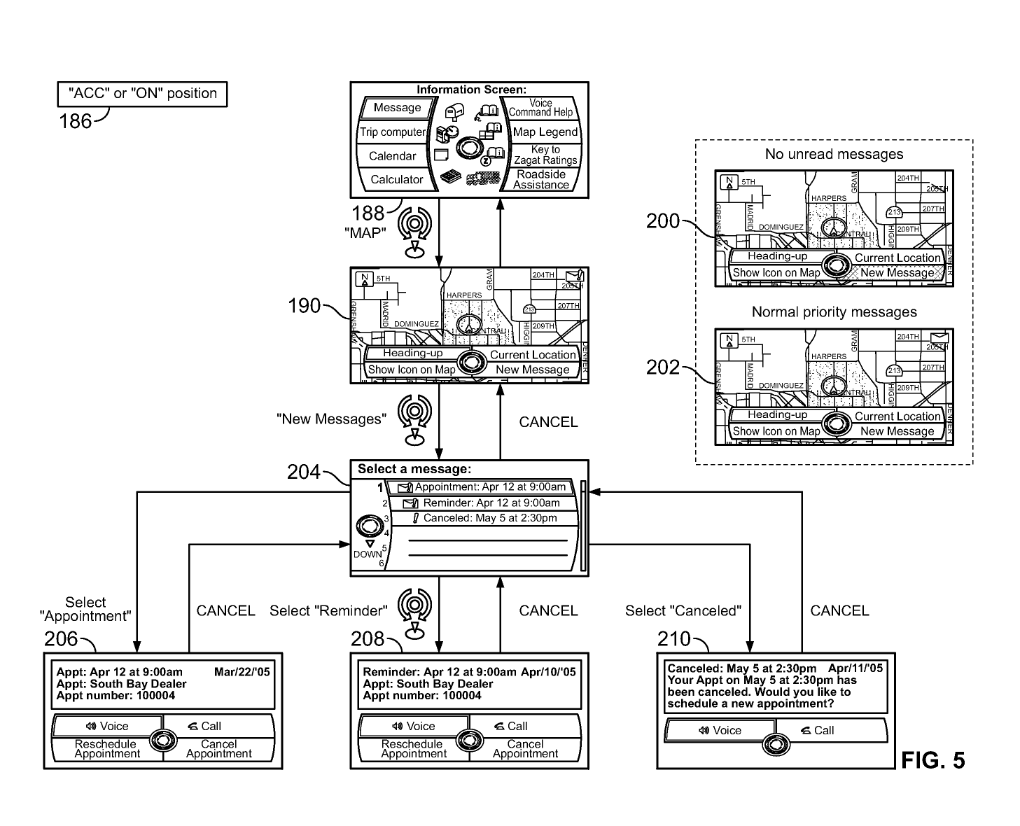

FIG. 6 illustrates a screen image flow diagram that illustrates different types of appointment messages that can be displayed on the NAVI display 64 of the onboard system 82 according to an embodiment of the system and method. At step 188, the user selects the MAP screen and a menu is superimposed on a portion of the map shown on the NAVI display 64. The system starts operation or starts-up when the user sets the vehicle's ignition switch to the “ON” or “Accessory” position in step 186. After the system initiates, the NAVI display 64 displays an information screen at step 188 wherein, the user can select a variety of functions such as reading SMS messages, viewing her calendar, calling for roadside assistance, and the like. The user can do so by a variety of ways such as touching the appropriate portion of the NAVI display 64, depressing a keypad or keyboard key, or vocalizing a recognized command wherein, a VR system (not shown) recognizes the user's spoken commands. For example, the user can speak the command “Map” and the NAVI display 64 will proceed to displaying a map as shown in 190. Note that user input commands in FIGS. 5 and 6a-c can be selected by these methods as well as other command selection methods known to those of skill in the art.

In the upper right hand corner of the map screen in step 190, an envelope icon is used to notify the user of the receipt of a new SMS message by the onboard system 82; however, other types of icons can be used as well. Steps 200 and 202 represent different screen images that can appear in place of the screen image illustrated at step 198, depending on the status of unread messages. If there are no unread or unviewed messages, the envelope icon will not appear on the map screen, as shown in step 200. A normal priority message is depicted as an envelope in step 202, while a high priority message appears as an envelope icon with an exclamation point. The messages that are linked to these envelope icons can be appointment related messages, vehicle event messages (such as a product update message received from a remote location (e.g., remote server 72 (shown in FIG. 2)), generated by the onboard system 82 (shown in FIG. 2) in response to a detected sensor reading from a vehicle subsystem (not shown), or possibly text messages received from the satellite radio server 74 (shown in FIG. 2). In other embodiments, the messages received can be SMS messages from a friend or other service provider via the user's cellular telephone or her personal digital assistant (e.g., the wireless device 16 (shown in FIG. 1d)). A high priority message can be one where the user needs to immediately stop driving her car or schedule an appointment to avoid personal injury or severe damage to her vehicle. A normal priority message can be a maintenance type reminder, such as the need to schedule a 15,000 mile service appointment within the next 500 miles. One of skill in the art will recognize that other types of icons or indicators can be displayed at steps 190, 200, and 202 to indicate the arrival of unread messages.

The user can proceed to step 204 from steps 198, 200, or 202 by selecting “New Messages” or proceed back to the information screen at step 188 by any of the methods discussed above. At step 204, the screen displays either the new unread SMS messages or in another embodiment, all messages in the systems (that were not previously deleted). The user can then select which of the messages she wishes to view in detail by selecting the “down” image on the NAVI Display 64, vocalizing her selection, or the use of other selection methods, as discussed above.

The screen images displayed for steps 206, 208, and 210 show various types of appointment related messages in the upper portion of the screen images and a menu of available commands in the lower portion of the images, after the user selects “Appointment,” “Reminder,” or “Cancel,” respectively, from step 204. In step 206, the user can view a message received when the user sets a particular service appointment. In step 208, the user can view a reminder message regarding a previously set, upcoming service appointment. In step 210, the user can view a message about an upcoming appointment the user has cancelled. From steps 206-210, the user is presented with a menu of choices such as “Voice,” “Call,” “Reschedule Appointment,” and “Cancel Appointment.” Selecting “Voice” causes the system to read the message to the user over the vehicle's audio system 86 (shown in FIG. 2) by using a TTS engine that can be integrated with the onboard system 82. Selecting “Call” causes the onboard system to initiate a voice mode phone call to the car dealer that appears in the message (shown in FIG. 2 and discussed thereto), but in other embodiments, the sender of other received messages can be called as well. The user can also cancel any further action from the message details appearing in the screen images at steps 206-210 and the system returns to step 204. The “Reschedule Appointment” and “Cancel Appointment” functions will be discussed further below with respect to FIGS. 6b-c, below).

FIG. 6a is a screen image flow diagram for finding a service dealer for making an automated appointment via the onboard system 82 according to an embodiment of the system and method. At step 212, the NAVI display 64 shows the image of a service reminder message that is applicable to the user's specific vehicle and has been received by the IP unit 84 (shown in FIG. 2), the NAVI 38 (shown in FIG. 1d), and the NAVI device 14 (see FIG. 1c), as described above. The user can hear the message via the TTS engine by selecting “Voice,” phone the dealer to manually schedule an appointment by selecting “Call Your Dealer,” find the nearest or desired dealer by selecting “Find Dealer,” or schedule an appointment via the onboard system 82, by selecting “Schedule Dealer Appointment.” Before the “Call Your Dealer” or “Schedule Dealer Appointment” selections are made, the user preferably has set her preferred car dealer for servicing her vehicle either via the vehicle owner web portal 94 (shown in FIG. 2 and related discussion, above) or she has selected “Find Dealer” from step 212 previously. The user may also change the dealer preference previously set by these methods whenever a new service-related message appears on the NAVI display 64 by selecting “Find Dealer.”

When the user selects “Find Dlr.” or “Find Dealer,” the NAVI display 64 shows a screen image listing the nearest car dealers to the vehicle's current location, as determined by the navigational device 14, NAVI 38, or IP unit 84. The user can select the desired dealer by touching the listed dealer name on the NAVI display 64, vocalizing her selection number or by other methods known to one of skill in the art. The list can be scrolled to further dealer names when applicable, by touching the “Down” image or vocalizing “Down.” In other embodiments, the list of dealers can be a list of dealers closest to the user's home address, work address, or other address the user sets in the IP unit 84. After the desired dealer is selected in step 214, the system returns to step 212.

FIG. 6b is a screen flow image diagram for scheduling an automated appointment after a product update message is displayed on the NAVI display 64 of the onboard system 82 according to an embodiment of the system and method. In step 252, the user is presented with a product update screen image that is similar to the maintenance reminder screen image in step 212 (shown in FIG. 6a); however, in FIG. 6b the user has previously selected “Find Dealer” and now selects “schedule dealer appointment.” The system now proceeds to step 254 and a confirmation screen is displayed that prompts the user before the system goes “ONLINE” and connects to the remote server 72 (shown in FIG. 2) at a remote site via the IP back channel 102 (shown in FIG. 3), using the cellular data line and the Bluetooth Cellular phone 92 (shown in FIG. 2). If the user selects “No” or cancels the confirmation function, the system returns to step 252. If “Yes” is selected, the system proceeds to step 258 and connects to the remote server 72. Note that whenever the IP unit 84 connects or attempts to connect to the remote server 72, the system status is “ONLINE” as shown in steps 256.

In one embodiment, the system presents the user with a warning screen stating that if they are currently communicating on the cellular audio line, that phone call will be disconnected when the user confirms connection to the remote server 72 in step 254 and goes online by selecting “Yes.” In another embodiment, if the user has set a preference for the message setup screen to automatically connect to the remote server 72, the confirmation screen at step 254 will be skipped and the system will instead proceed to step 258.

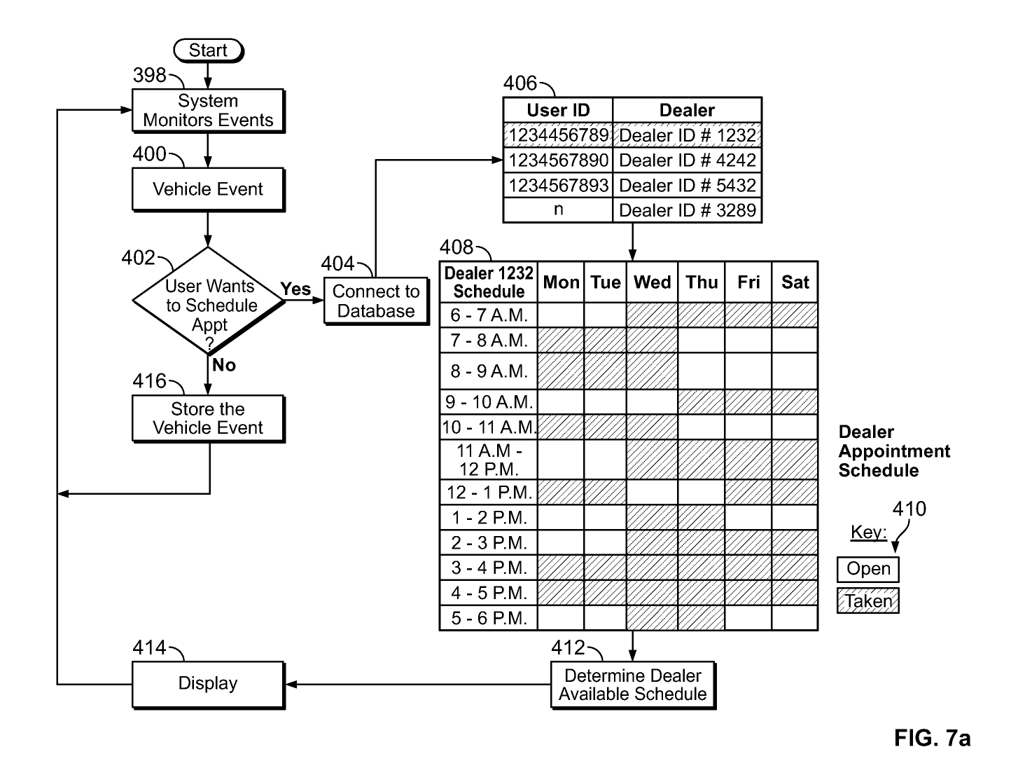

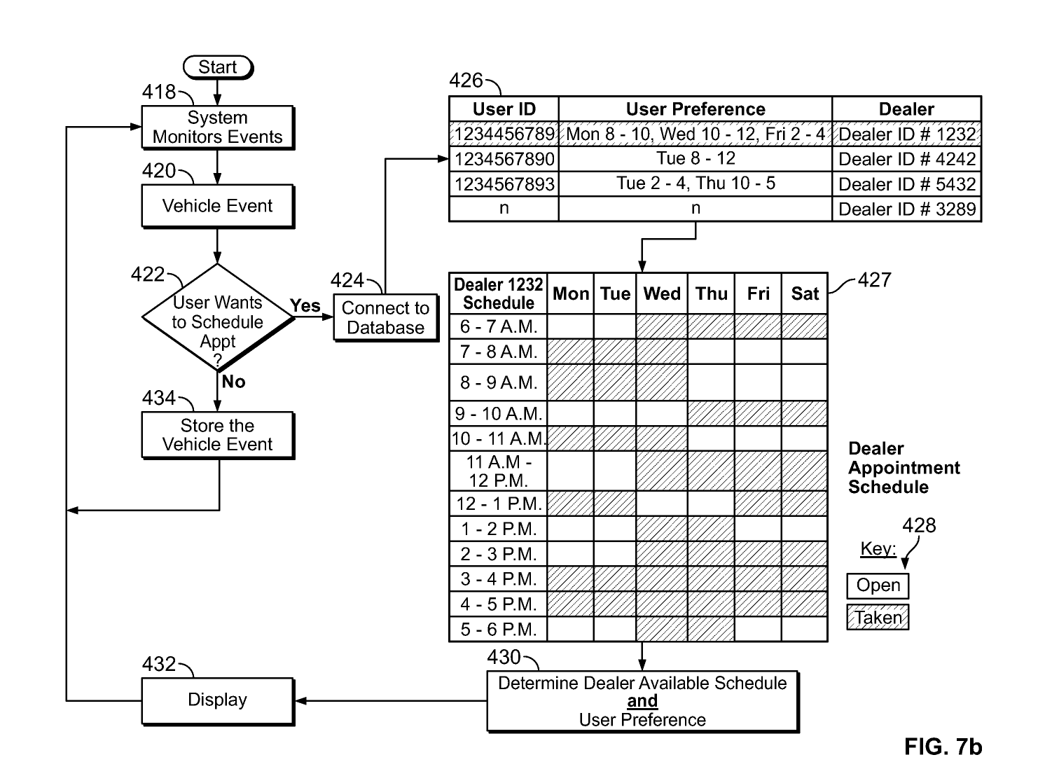

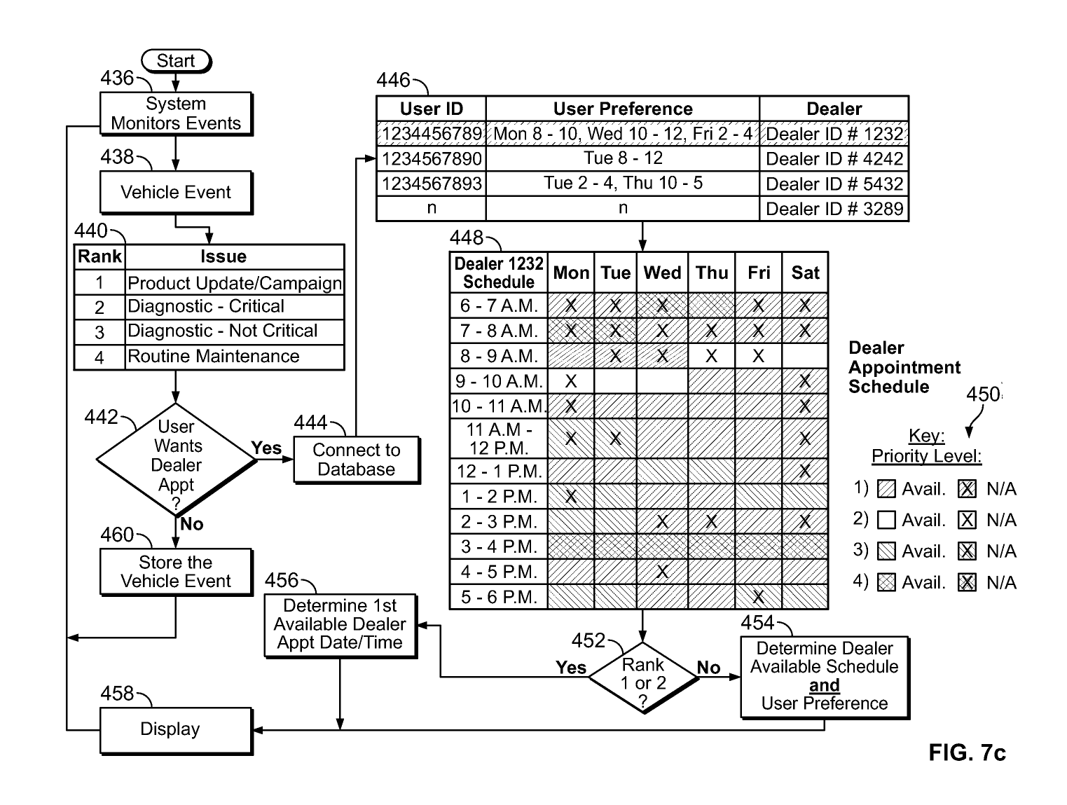

In step 258, the system attempts to connect to the remote server 72 and a progress graph can be displayed to the user. If the user does not cancel the operation, once the communication succeeds, a proposed available appointment date and time is displayed to the user at step 260. Various methods of selecting the appointment to present to the user are discussed with respect to FIGS. 7a-7c, below. If the user selects “Confirm Appointment,” the system again attempts to connect to the remote server 72 at step 262. If the user selects any key or “Cancel” at step 258, the system cancels the operation and the system returns to step 270 (discussed below). In another embodiment, the system instead returns the NAVI screen 64 to the image that was displayed prior to screen image 252 (which can comprise the map image screen or other NAVI screens such as the Information screen 188 (shown in FIG. 5)).

Returning to step 260, the system attempts to communicate with the remote server 72 to confirm the desired appointment at step 262. If the user selects “Cancel” before a successful communication with the remote server 72 is made, the system returns to step 252 and the NAVI Display 64 once again displays the product update message. Once the system successfully communicates with the remote server 72 at step 262, a confirmation message for the set appointment date and time appears on the screen image at step 264. If the user then selects either “OK” or “Cancel,” the system proceeds to step 286 via entry point “C” at step 284, where a screen image similar to that of step 252 appears for any remaining service related messages for which a service appointment still needs to be set-up. For a confirmed appointment relating to a particular message received, the “Schedule Dealer Appointment” option is now shaded or grayed-out or disabled and the user can also choose to delete the message by selecting “Delete.” Once again returning to step 260, if the user selects “Call”, the system can initiate a telephone call to the dealer to set an appointment on the cellular audio line (shown in FIG. 2). If no phone call is initiated, the NAVI display 64 returns to the screen image of step 252.

In another embodiment, the same set of screen flow images of FIG. 6b can be used for scheduling a dealer appointment after a maintenance reminder message is displayed to the user, such as the image displayed in step 212 (shown in FIG. 6a), wherein only the text of the message displayed in step 252 differs from the product update message discussed above. Similarly, the same set of screen images can be used for rescheduling an appointment when an appointment listing screen is displayed (not shown), with the text of the screen image in step 252 being replaced with the details of a previously set appointment (e.g., date and time) or a reminder message screen (not shown) for the previously set appointment and the option of rescheduling an appointment is displayed to the user in the onscreen menu at step 252 in place of the option of scheduling an appointment.

FIG. 6c is a screen flow image diagram for canceling an automated appointment after an appointment reminder message is displayed on a NAVI screen 64 of the onboard system 82 according to an embodiment of the system and method. At step 326, the NAVI display 64 shows an image for an appointment that has previously been set and can be periodically displayed to the user at preset date and time intervals prior to the scheduled service appointment. The message provides information about the set appointment that can include the appointment date, appointment time, appointment number, dealer name, and the date the reminder message was sent, though other information relating to the appointment can be displayed in the reminder message as well (e.g., location of the dealer, type of service to be performed at the appointment, and the like). The lower portion of the display image shows a menu with commands the user can execute, such as “Voice,” “Call,” “Reschedule Appointment,” and “Cancel Appointment.” The operation of all but the “Cancel” function have been described above (see FIGS. 6a-b and discussion thereto).

At step 328, the screen image of an appointment message is shown. This message can be selected for viewing by the user from various NAVI display screens, such as the information screen of step 188 or the message selection screen of step 204 (shown in FIG. 5). The appointment message provides information about a previously set appointment and can include the same information as the screen image at step 326, but with the substitution of the word “Reminder” with the abbreviation “Appt.” (short for “Appointment”). The lower portion of the display image (not visible) shows a menu with commands the user can execute. The commands can be the same as those visible in the bottom portion of the screen image for the appointment message screen in step 326, but other commands can be displayed as well.

If the user selects “Cancel Appointment” from either step 326 or 328, the confirmation screen image is displayed at step 330. This screen displays a message prompting the user to confirm that she wants to both cancel an existing dealer appointment and that she wishes to connect to the remote server 72 located at the remote site, though other confirmation messages can be displayed to the user as well. If the user selects “Yes” by touching the appropriate portion of the NAVI display 64 or speaks the desired command, the system proceeds to go online at step 332 and attempts to connect to the remote server 72 at step 334. As discussed above with respect to FIGS. 5-6b, other methods for the user to select desired commands are within the spirit and scope of the system and method disclosed herein. Note that whenever the IP unit 84 connects or attempts to connect to the remote server 72, the system status is “ONLINE” as shown in step 334.

In one embodiment, the system presents the user with a warning screen stating that if they are currently communicating on the cellular audio line, that phone call will be disconnected when the user confirms connection to the remote server 72 in step 330 and goes online by selecting “Yes.” In another embodiment, if the user has set a preference for the message setup screen to automatically connect to the remote server 72, the confirmation screen at step 330 will be skipped and the system will instead proceed to step 334.

If the communication to the remote server 72 succeeds, a confirmation message appears on the NAVI display 64 at step 336 showing the appointment date and time that will be cancelled after the user selects “OK.” Then, at step 350, a screen image appears showing the cancelled appointment in the upper potion of the NAVI display screen 64 and in the lower portion the “Voice” and “Call” options are displayed in a menu so that he user so that she can have the system read the cancelled appointment information out load or the system can initiate a telephone call to the dealer using the cellular audio line (shown in FIG. 2) and the wireless device 16 (shown in FIG. 1d) to enable the user to reschedule the appointment or to receive more information about the needed service for her vehicle. If the user attempts to cancel the connection attempt to the remote server 72 at step 334 by selecting “Cancel,” the system returns to originating step 326 or 328 as appropriate and the appointment or appointment reminder screen image is again displayed on the NAVI screen 64.

FIG. 7a is a flow diagram of an embodiment of a method for making automated appointments using a dealer's schedule. At step 398, the onboard system 82 (shown in FIG. 2) monitors the occurrence of vehicle events, which can include events generated from systems in the user's vehicle or events transmitted to the vehicle from the satellite 367 (such as product update notices and maintenance reminders). At step 400, a vehicle event is detected by the onboard system 82. At step 402, the system informs the user of the vehicle event detected and prompts the user to schedule a service appointment using the automated appointment system with a message about the detected vehicle event. The user can be notified of the vehicle event by a variety of ways including a message on the display 88 (shown in FIG. 2) or by a TTS audio message on the audio system 86 (shown in FIG. 2). If the user does not choose to schedule an appointment via the automated appointment system (shown in FIG. 3 and related discussion, above), the system stores the vehicle event occurrence and returns to step 398 and continues monitoring for other vehicle events.

If the user chooses to schedule an appointment using the automated system in step 402, the IP unit 84 (shown in FIG. 2) communicates with the remote server 72 over a cellular data line using the Bluetooth HF unit 90 (shown in FIG. 2) and the Bluetooth Cellular phone 92 (shown in FIG. 2) to request an appointment date and time. The user's scheduling preference settings (as to her preferred servicing dealer) are retrieved from a database of user profiles on the remote server 72 (such as the information platform/web portal database 112 (shown in FIG. 3) in step 406. The dealer's appointment schedule and the dealer profile for the user's desired servicing dealer are then identified and retrieved from the appointment scheduling/e-commerce database 114 (shown in FIG. 3) at step 408. Item 410 is the key to the table or database. In FIG. 7a, open areas are shown as white or blank cells and taken or unavailable dates and time slots are shown as shaded cells. Other methods of distinguishing open and available tie slots can be used such as numbering or using different types of shading; however, it should be noted that the table in step 408 is merely a representation of an electronic database or table for explanatory purposes and as such, the actual representation of data in the database or table does not necessarily include shading or colorization. The table stores the dealer's appointment schedule for the user's desired dealer as indicated by the corresponding entry in the table or database (e.g., the appointment scheduling/e-commerce database 114) in step 406. It will be understood by those of skill in the art that there are similar dealer appointment schedules stored in this database for other vehicle users. Computations are performed by the system using the table or database stored on the appointment scheduling/e-commerce database 114 to determine the dealer's available schedule and to propose the available appointment dates and times to the user in step 412 and are displayed to the user via the onboard system 82 (e.g., the display 88) in step 414. Other factors in arriving at the proposed appointment dates and times can be considered by the system and will be discussed below with respect to FIGS. 7b-c (e.g., the user's preferences and/or the severity of the vehicle event). The user can then make her selection and the method returns to step 398, where the onboard system 82 continues to monitor for vehicle events. It should be noted that the computations to determine the dealer's available schedule in step 412 can occur at the servers 72 or in another embodiment, can occur at the onboard system 82.

FIG. 7b is a flow diagram of an alternate embodiment of a method for making automated appointments using a dealer's schedule and the customer's preference settings. Most of the scheduling computations called for in the method are performed at the remote server 72 (shown in FIG. 2).

In a first embodiment, the onboard system 82 (shown in FIG. 2) monitors the occurrence of vehicle events at step 418. When a vehicle event occurs at step 420, the vehicle event information is communicated to the remote server 72 using the cellular data line (shown in FIG. 2 and related discussion, above), that receives information about the vehicle events that occurred for a particular user's vehicle. The vehicle events received can include vehicle identification information, vehicle diagnostic trouble codes triggered in the vehicle by various onboard systems (e.g., an antilock braking system, a steering system, or a climate control system), and/or a product update message. At step 422, the system informs the user of the vehicle event detected and prompts the user to schedule a service appointment using the automated appointment system with a message about the detected vehicle event. If the user does not choose to schedule an appointment via the automated appointment system (shown in FIG. 3 and related discussion, above), the system stores the vehicle event occurrence and returns to step 418 and continues monitoring for other vehicle events.

If the user chooses to schedule an appointment using the automated system in step 424, the IP unit 84 communicates with the remote server 72 over a cellular data line using the Bluetooth HF unit 90 (shown in FIG. 2) and the Bluetooth Cellular phone 92 (shown in FIG. 2) to request an appointment date and time. The server 72 identifies the dealer to service the vehicle event. This can be accomplished by prompting the user with a series of screen images on the display 88 (shown in FIG. 2) or NAVI screen 64 (see FIG. 6a and related discussion, above). Alternatively, the server 72 checks if the user's scheduling preference settings (as to her preferred servicing dealer) are stored in a database of user profiles on the remote server 72 (such as the information platform/web portal database 112 (shown in FIG. 3) in step 426. The dealer's appointment schedule and the dealer profile for the user's desired servicing dealer are then identified and retrieved from the appointment scheduling/e-commerce database 114 (shown in FIG. 3) at step 427. Item 428 is the key to the white and shaded areas in the table or database of the dealer's appointment schedule. Similar dealer appointment schedules are stored in this database for other vehicle users. In step 430, the server 72 selects a preference-based appointment date and time in the dealer schedule according to the scheduling preferences of the user, when they have been included in the user's profile using the table or database stored on the appointment scheduling/e-commerce database 114 to propose the available appointment dates and times to the user and the proposed time slot is displayed to the user via the onboard system 82 (e.g., the display 88) in step 432.

When the user profile does not include the user's scheduling preferences, at step 430 the server 72 selects a first available appointment date and time in the dealer schedule.

In a variation of the first embodiment, the method further comprises determining a priority ranking of the vehicle event (shown as step 440 in FIG. 7c) before the IP unit 84 communicates with the server 72 at step 424. Often, multiple vehicle events can be triggered from one particular vehicle issue that has occurred. Thus, when the server 72 selects a preference-based appointment date and time at step 430, the server considers the priority ranking of multiple vehicle events that may have been received (shown as step 452 in FIG. 7c). When the priority rank of the vehicle event meets a predefined priority level, the server 72 selects the first available appointment in the dealer schedule for the identified servicing dealer, regardless of whether the user's profile includes her scheduling preferences (shown as step 456 in FIG. 7c).

After the proposed appointment date and time are displayed to the user in step 432, the user can select the appointment on the onboard system 82 (shown in FIG. 2) and the proposed appointment slot will be reserved. If the user does not select the proposed appointment slot during a predetermined time, the proposed appointment slot will be released and made available to other users (shown in FIG. 2 and related discussion, above).

In a second embodiment, the onboard system 82 (shown in FIG. 2) monitors the occurrence of vehicle events at step 418. When a vehicle event is detected at step 420, the vehicle event information is sent to the remote server 72 using the cellular data line (see FIG. 2 and related discussion, above), which receives information about the vehicle events that occur for a particular user's vehicle. The vehicle events detected can include detecting mileage-based events (e.g., a tune-up is needed at 30,000 miles on the vehicle), condition-based events (e.g., the radiator hoses need to be replaced if they are the original supplied hoses and the vehicle is more than two years old), vehicle DTC's, and/or a product update message. At step 422, the system informs the user of the vehicle event detected and prompts the user to schedule a service appointment using the automated appointment system with a message about the detected vehicle event. If the user does not choose to schedule an appointment via the automated appointment system (shown in FIG. 3 and related discussion, above), the system stores the vehicle event occurrence and returns to step 398 and continues monitoring for other vehicle events.

If the user chooses to schedule an appointment using the automated system in step 424, the IP unit 84 communicates with the remote server 72 over a cellular data line using the Bluetooth HF unit 90 (shown in FIG. 2) and the Bluetooth Cellular phone 92 (shown in FIG. 2) to request an appointment date and time. The server 72 identifies the dealer to service the vehicle event. Steps 426-428 are as described above in the first embodiment. The IP unit 84 receives a preference-based appointment time in a dealer schedule according to the scheduling preferences of the user when the user has provided the scheduling preferences in a user profile. When the user profile does not include the user's scheduling preferences, a first available appointment is determined, (as discussed with respect to the first embodiment, above), and the IP unit 84 receives a first available appointment date and time in the dealer schedule.

In a variation of the second embodiment, the method further comprises determining a priority ranking of the vehicle event (shown as step 440 in FIG. 7c) before the IP unit 84 communicates with the server 72 at step 424, as discussed above with respect to the first embodiment. When the priority rank of the vehicle event meets a predefined priority level, regardless of whether the user profile includes the scheduling preferences, the IP unit receives a first available appointment date and time that is determined at step 430 and displayed to the user in step 432.

After the proposed appointment date and time are displayed to the user in step 432, the user can select the appointment on the onboard system 82 (shown in FIG. 2) and a command is sent to the remote server 72 to reserve the proposed appointment date and time. If the user does not select the proposed appointment slot during a predetermined time, a command is sent to the remote server 72 to release the proposed appointment slot and make the appointment slot available to other users (see FIG. 9 and related discussion, above).

FIG. 7c is a flow diagram of an alternate embodiment of a method for making automated appointments based on the ranking of the severity of the issue necessitating an appointment. The method is similar to the method discussed above with respect to FIGS. 7a-b, with steps 436, 438, 442, 444, 446, 460, 454, 456, and 458 being the same or similar to corresponding steps 418, 420, 422, 424, 426, 434, 430, 412, and 432, respectively. Only two steps in FIG. 7c vary from the steps in FIGS. 7a-b; namely, steps 448 and 450 vary from steps 427 and 428, while steps 440 and 452 are additional steps not present in FIGS. 7a-b. More specifically, the table or database in step 448 holds additional information for the dealer's schedule, namely the various appointment slots available in a given week are divided up by priority levels. Further the designations “open” and “taken” in the key shown in item 428 have been replaced by the designations “Avail.” and “N/A,” which stand for “Available” and “Not Available,” but essentially have the same meaning as “open” and “taken,” in reference to appointment slots in the table of step 448 and step 427, respectively. The additional ranking information stored in the Dealer Appointment Schedule table at step 448 is used in steps 452 and 440 in determining a proposed service appointment date and time.

Following the detection of a vehicle event in step 438, the IP unit 84 (shown in FIG. 2) determines the rank of the vehicle event or vehicle issue with a priority level of 1 to 4, level 1 being the most severe or critical level to be addressed by a dealer appointment. As illustrated there are four rankings, however, one of skill in the art will appreciate that a greater or lesser number of priority levels or rankings can be utilized in analyzing the vehicle event at step 440 as well as the largest or highest ranking number being the most critical to address at a dealer appointment. As illustrated, rank level 1 are product update/campaigns and diagnostic codes or DTC's that are critical are ranked at level 2, but in other embodiments, other vehicle issues can be predetermined to correspond with ranking levels 1 and 2. The ranking information determined at step 440 is analyzed at step 452, where the system determines the methodology to employ in arriving at a proposed dealer appointment date and time; namely, whether to proceed to step 454 or 456.

More specifically, if the ranking of the vehicle event is ranked at levels 1 or 2, the system proceeds to step 456 and determines the first available appointment at the user's preferred dealer, as was done at step 412 in FIG. 7a, thereby ignoring the user's preference setting that is stored in the table at step 446. A difference in the results from step 456 vs. step 412 is that there are specific appointment date and time slots designated for rank 1 and 2 appointments in the dealer appointment schedule table at step 448, whereas in step 412 of FIG. 7a, no distinction was made as to appointments being set aside for the various vehicle event ranking levels. One of skill in the art will recognize that the “if then” condition tested by the method in step 452 can vary (such as setting the test at levels 1, 2 or 3). On the other hand, if the ranking level of the vehicle event is not level 1 or 2 (e.g., level 3 or more), the method proceeds to step 454 and the proposed appointment date and time is determined using the dealer's appointment schedule and the user's preference settings, as was done in step 430, but once again the difference in step 454 being that the available dealer appointment slots will be those with rankings of 3 or more. Following the computations of the proposed appointment date and time in steps 456 and 454, the method proceeds to step 458 to display the proposed appointment slot to the user, as described above with respect to step 414.

Having thus described a preferred embodiment of a method and system for requesting and scheduling service appointments from a remote site via an onboard system that considers the schedule of a preferred dealer, it should be apparent to those skilled in the art that certain advantages of the within system have been achieved. It should also be appreciated that various modifications, adaptations, and alternative embodiments thereof may be made within the scope and spirit of the system and method disclosed herein. For example, various embodiments have been presented with different criteria utilized in scheduling appointment dates and times for servicing vehicles, but it should be apparent that many of the inventive concepts described above would be equally applicable for scheduling service appointments for other types of vehicle and complex equipment such as aircraft, buses, trucks, motorcycles, and industrial equipment (e.g., manufacturing equipment such as CNC machinery, printing presses, fork lifts, and the like).

What is claimed is:

1. A method for scheduling vehicle service appointments for a vehicle user, comprising:
receiving information about a vehicle event;
identifying a dealer to service the vehicle event;
accessing a dealer schedule of the identified dealer;
determining whether the user has provided scheduling preferences in a user profile;
selecting a preference-based appointment time in the dealer schedule according to the scheduling preferences when the user profile includes the scheduling preferences;
selecting a first available appointment time in the dealer schedule when the user profile does not include the scheduling preferences; and
sending a proposed appointment time to a vehicle user, the proposed appointment time comprising one of the preference-based appointment time and the first available appointment time.

2. The method of claim 1, further comprising:
determining a priority rank of the vehicle event; and
selecting the first available appointment time in the dealer schedule when the priority rank of the vehicle event meets a predefined priority level, regardless of whether the user profile includes the scheduling preferences.

3. The method of claim 1, further comprising reserving the proposed appointment time when the user selects the proposed appointment time.

4. The method of claim 1, further comprising releasing the proposed appointment time when the user does not select the proposed appointment time during a predetermined response period.

5. The method of claim 1, wherein receiving information about the vehicle event comprises receiving vehicle identification information.

6. The method of claim 1, wherein receiving information about the vehicle event comprises receiving a diagnostic trouble code.

7. The method of claim 1, wherein receiving information about the vehicle event comprises receiving a product update message.

8. The method of claim 1, wherein identifying the dealer to service the vehicle event comprises retrieving data from the user profile.

9. A method for scheduling vehicle service appointments for a vehicle user, comprising:
detecting a vehicle event;
sending vehicle information to a remote site; and
receiving a proposed appointment time with a dealer from the remote site, comprising:
receiving a preference-based appointment time in a dealer schedule according to scheduling preferences of the user when the user has provided the scheduling preferences in a user profile; and
receiving a first available appointment time in the dealer schedule when the user profile does not include the scheduling preferences.

10. The method of claim 9, further comprising receiving the first available appointment time in the dealer schedule when a priority rank of the vehicle event meets a predefined priority level, regardless of whether the user profile includes the scheduling preferences.

11. The method of claim 9, further comprising sending a command to the remote site to reserve the proposed appointment time when the user selects the displayed appointment time.

12. The method of claim 9, further comprising sending a command to the remote site to release the proposed appointment time when the user does not select the displayed appointment time during a predetermined response period.

13. The method of claim 9, wherein detecting the vehicle event comprises detecting a mileage-based event.

14. The method of claim 9, wherein detecting the vehicle event comprises detecting a condition-based event.

15. The method of claim 9, wherein detecting the vehicle event comprises receiving a diagnostic trouble code.

16. The method of claim 9, wherein detecting the vehicle event comprises receiving a product update message.

17. A system for scheduling vehicle service appointments for a vehicle user, comprising:
a receiver unit for receiving information about a vehicle event;
a processor unit that is operatively coupled to the receiver unit and programmed to:
identify a dealer to service the vehicle event;
access a dealer schedule of the identified dealer;
determine whether the user has provided scheduling preferences in a user profile;
select a preference-based appointment time in the dealer schedule according to the scheduling preferences when the user profile includes the scheduling preferences; and
select a first available appointment time in the dealer schedule when the user profile does not include the scheduling preferences; and
a transmitter unit that is operatively coupled to the processor unit for sending a proposed appointment time to a vehicle user, the proposed appointment time comprising one of the preference-based appointment time and the first available appointment time.

18. The system as recited in claim 17, wherein the processor unit is further programmed to:
determine a priority rank of the vehicle event; and
select the first available appointment time in the dealer schedule when the priority rank of the vehicle event meets a predefined priority level, regardless of whether the user profile includes the scheduling preferences.

19. The system as recited in claim 17, wherein the processor unit is further programmed to reserve the proposed appointment time when the user selects the proposed appointment time.

20. The system as recited in claim 17, wherein the processor unit is further programmed to release the proposed appointment time when the user does not select the proposed appointment time during a predetermined response period.

21. The system as recited in claim 17, wherein the receiver unit receives vehicle identification information.

22. The system as recited in claim 17, wherein the receiver unit receives a diagnostic trouble code.

23. The system as recited in claim 17, wherein the receiver unit receives a product update message.

24. The system as recited in claim 17, wherein the processor identifies the dealer by retrieving data from the user profile.

25. A system for scheduling vehicle service appointments, comprising:
a detector for detecting a vehicle event;
a transmitter unit;
a processor unit that is operatively coupled to the detector and transmitter unit, the processor unit being programmed to instruct the transmitter unit to send vehicle information to a remote site when the detector detects the vehicle event;
a receiver unit that receives a proposed appointment time with a dealer from the remote site, wherein the receiver unit receives a preference-based appointment time in a dealer schedule according to scheduling preferences of the user when the user has provided the scheduling preferences in a user profile, and wherein the receiver unit receives a first available appointment time in the dealer schedule when the user profile does not include the scheduling preferences; and
a display unit for displaying the proposed appointment time for the user.

26. The system as recited in claim 25, wherein the receiver unit receives the first available appointment time in the dealer schedule when a priority rank of the vehicle event meets a predefined priority level, regardless of whether the user profile includes the scheduling preferences.

27. The system as recited in claim 25, wherein the transmitter unit sends a command to the remote site to reserve the proposed appointment time when the user selects the displayed appointment time.

28. The system as recited in claim 25, wherein the transmitter unit sends a command to the remote site to release the proposed appointment time when the user does not select the displayed appointment time during a predetermined response period.

29. The system as recited in claim 25, wherein the detector detects a mileage-based event.

30. The system as recited in claim 25, wherein the detector detects a condition-based event.

31. The system as recited in claim 25, wherein the transmitter unit sends a diagnostic trouble code to the remote site.

32. The system as recited in claim 25, wherein the receiver unit receives a product update message.
